(19) United States
(12) Patent Application Publication
(10) Pub. No.: US 2024/0289543 A1
(43) Pub. Date: Aug. 29, 2024

(54) METHOD, APPARATUS, TERMINAL AND STORAGE MEDIUM FOR INFORMATION PROCESSING

(71) Applicant: Beijing Zitiao Network Technology Co., Ltd., Beijing (CN)

(72) Inventor: Zhifeng Lin, Beijing (CN)

(21) Appl. No.: 18/590,644

(22) Filed: Feb. 28, 2024

(30) Foreign Application Priority Data
Feb. 28, 2023 (CN) 202310193326.X

(51) Int. Cl. G06F 40/177; G06F 16/9038; G06F 16/93

(52) U.S. Cl. CPC G06F 40/177; G06F 16/9038; G06F 16/93

(57) ABSTRACT

The present disclosure provides an information processing method, apparatus, terminal and storage medium. The information processing method comprises: creating a group field in a target table of a first document in response to a first operation event; associating a target cell corresponding to the group field with at least one target group in response to a second operation event; opening or joining the target group in response to a third operation event based on the target cell; wherein the group field is a field with a field type of group. Therefore, the field type becomes more diversified and a quick jump of groups is implemented.

### CROSS-REFERENCE TO RELATED APPLICATION(S)

This application claims priority to Chinese Application No. 202310193326.X filed Feb. 28, 2023, the disclosure of which is incorporated herein by reference in its entity.

### FIELD

The present disclosure relates to the field of computers, and more specifically, to a method, apparatus, terminal and storage medium for information processing.

### BACKGROUND

Documents, such as online documents, may contain tables. Different contents may be input to various fields of the table via the table.

### SUMMARY

The present disclosure provides an information processing method, apparatus, terminal and storage medium.

The present disclosure adopts following technical solutions.

In some embodiments, the present disclosure proposes an information processing method, comprising:
creating a group field in a target table of a first document in response to a first operation event;
associating a target cell corresponding to the group field with at least one target group in response to a second operation event;
opening or joining the target group in response to a third operation event based on the target cell;
wherein the group field is a field with a field type of group.

In some embodiments, the present disclosure provides an information processing apparatus, comprising:
a creation unit for creating a group field in a target table of a first document in response to a first operation event;
a control unit for associating a target cell corresponding to the group field with at least one target group in response to a second operation event;
wherein the control unit also opens or joins the target group in response to a third operation event based on the target cell;
wherein the group field is a field with a field type of group.

In some embodiments, the present disclosure provides a terminal, comprising at least one memory and at least one processor;
wherein the memory is used for storing program codes and the processor is used for calling program codes stored in the memory to execute the above method.

In some embodiments, the present disclosure provides a computer readable storage medium for storing program codes, wherein the program codes, when executed by a computer, enables the computer to perform the above method.

The information processing method provided by embodiments of the present disclosure comprises: creating a group field in a target table of a first document in response to a first operation event; associating a target cell corresponding to the group field with at least one target group in response to a second operation event; opening or joining the target group in response to a third operation event based on the target cell; wherein the group field is a field with a field type of group. Therefore, the field type becomes more diversified and a quick jump of groups is implemented.

### BRIEF DESCRIPTION OF THE DRAWINGS

Through the following detailed implementations with reference to the accompanying drawings, the above and other features, advantages and aspects of various embodiments of the present disclosure will become more apparent. Throughout the drawings, same or similar reference signs indicate same or similar elements. It is to be understood that the drawings are exemplary, in which original components and elements are not necessarily drawn to scale.

FIG. 1 is a flowchart of an information processing method in accordance with embodiments of the present disclosure;

FIGS. 2 to 4 are schematic diagrams of the first document in accordance with embodiments of the present disclosure;

FIG. 5 is a schematic diagram of a target cell under different states in accordance with embodiments of the present disclosure;

FIGS. 6 to 8 are schematic diagrams of the first document in accordance with embodiments of the present disclosure;

FIG. 9 is a structural diagram of the electronic device in accordance with embodiments of the present disclosure.

### DETAILED DESCRIPTION OF EMBODIMENTS

The embodiments of the present disclosure will be described in more details with reference to the drawings. Although the drawings illustrate some embodiments of the present disclosure, it should be appreciated that the present disclosure can be implemented in various manners and should not be limited to the embodiments explained herein. On the contrary, the embodiments are provided to make the present disclosure more thorough and complete. It should be appreciated that the drawings and the embodiments of the present disclosure are provided only for exemplary purpose, rather than restricting the protection scope of the present disclosure.

It is to be understood that respective steps disclosed in the method implementations of the present disclosure may be executed in sequence and/or in parallel. Besides, the method implementations may include additional steps and/or omit the demonstrated steps. The scope of the present disclosure is not restricted in this regard.

As used herein, the term “includes” and its variants are to be read as open-ended terms that mean “includes, but not limited to.” The term “based on” is to be read as “based at least in part on.” The term “one embodiment” is to be read as “at least one embodiment.” The term “a further embodiment” is to be read as “at least a further embodiment.” The term “some embodiments” is to be read as “at least some embodiments”. Definitions of other terms may be provided in the following description.

It is to be noted that “first” and “second” disclosed in the present disclosure merely for distinguishing different apparatuses, modules or units, rather than restricting the sequence of the functions executed by the apparatuses, modules or units or the interdependency among the apparatuses, modules or units.

It is to be noted that the modification term “one” disclosed in the present disclosure is exemplary rather than restrictive. Those skilled in the art should understand that the above term is to be read as “one or more” unless indicated otherwise in the context.

Names of the messages or information exchanged between a plurality of apparatuses in the implementations of the present disclosure are provided only for explanatory purpose, rather than restricting the scope of the messages or information.

Solutions provided by embodiments of the present application are to be described in details below with reference to the drawings.

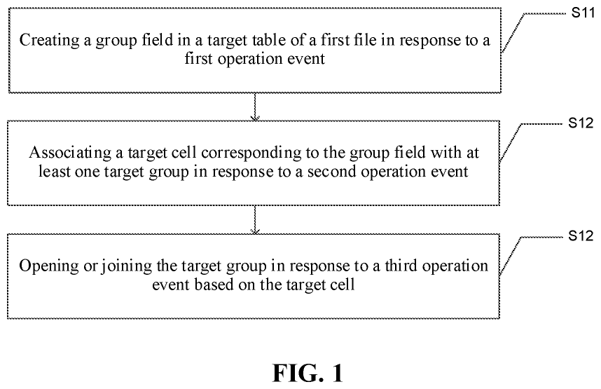

FIG. 1 illustrates a flowchart of an information processing method according to embodiments of the present disclosure. Following steps are included.

S11: creating a group field in a target table of a first document in response to a first operation event.

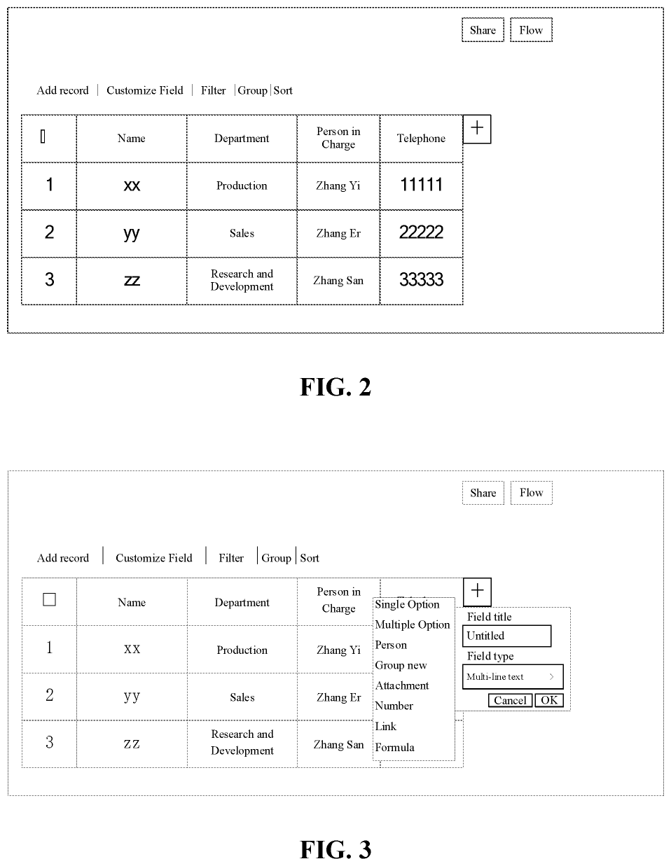

In some embodiments, the method proposed by the present disclosure may be applied to a terminal or a server. The first operation event may include one or more operations, the first document may be online document and the first document is accessed by accessing webpages. The first document also may be an offline document. The first document may be table document and also may be non-table document containing tables. As illustrated by FIGS. 2 and 3, the group field is created in the target table. The field is created for one column of data in the table. Once the creation of the field is completed, cells in this column are all configured as the field and contents filling in the cells match with the field. For example, name, department and person in charge in FIG. 2 are all fields. A new field may be created by clicking a box with addition sign at the top right corner of the table in FIG. 2 (see FIG. 3). Group field indicates a field of group type. In some embodiments, the field type may be used for restricting the content type to be input in the field. For example, the group field may be a group for inputting the group.

S12: associating a target cell corresponding to the group field with at least one target group in response to a second operation event.

In some embodiments, the second operation event may include one or more operations. The target cell may be associated with the target group by inputting or selecting a group in the group field to establish an association therebetween. The target cell may be associated with one group and also may be associated with a plurality of groups. The target cell may be one or more cells in a column of cells with group field attribute. The target group may be a normal group and also may be a topic group capable of sending a topic.

S13: opening or joining the target group in response to a third operation event based on the target cell.

In some embodiments, the third operation event may include one or more operations. The third operation event is an operation based on the target cell. For example, the user may open or join the target group associated with the target cell by an operation of clicking the target cell.

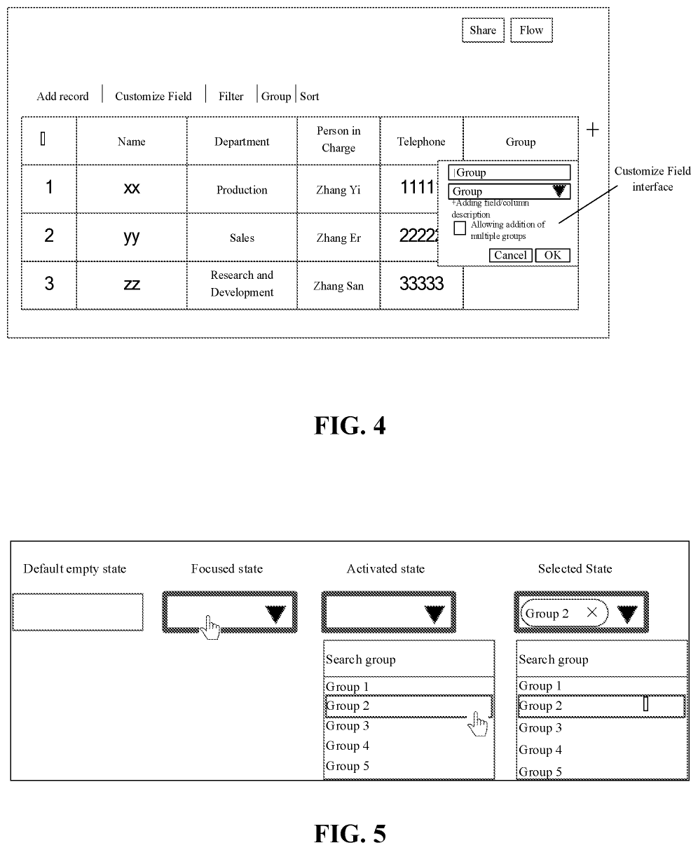

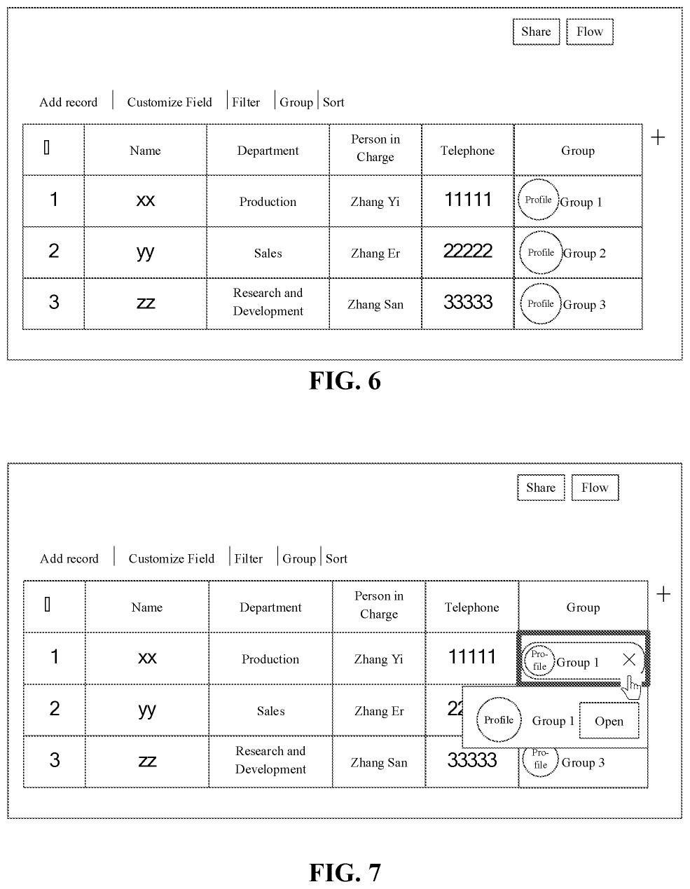

In some embodiments, an explanation is provided with reference to FIGS. 2 to 5. An interface for adding the field may appear by clicking the addition sign at the top right corner of FIG. 2. As shown in FIG. 3, title and field type options are displayed in the interface, where title is the name of the column where the field is positioned and supports texts and patterns; and the field type may be selected. As illustrated in FIG. 3, after an input box of the field type is triggered, an option list is displayed. The group type is displayed in the option list. Afterwards, the OK button is clicked to create a group field whose cells are not associated with groups. The creation of group field may indicate creating a column of cells with group field attribute, and also may be one or more cells. The target cell may be one cell of a column of cells with group field attribute. A customizing operation may be performed on the group field, e.g., activating the interface of the customize field. The customize field interface (an interface across phone column and group column with OK and CANCLE buttons) as shown in FIG. 4 may automatically pop up after the creation of the group field. In the customize field interface of FIG. 4, a first row of controls is used for configuring the title (“group” in FIG. 4), and a second row of controls where an inverted triangle is positioned are provided for configuring the field type (“group” in FIG. 4). The display controls are used for determining whether addition of a plurality of groups is allowed for the group field to configure whether the group field may be associated with a plurality of groups. For cells (e.g., target cell) in the group field, when they are not associated with groups, their display format may be the default empty state shown in FIG. 5. After the control mark selects the target cell, it is displayed in a focused state. At this moment, a control for selecting groups is displayed. After the triggering, optional groups and search controls (activated state) are displayed. Groups are selected as target groups (select state) for association. According to FIG. 6, when the target cells are associated with the target group, the associated target groups are displayed in the target cells (i.e., the cell where group 2 is positioned in the group column of FIG. 6 being the target cell). For example, the target groups in the target cells are clicked to open or join the target group.

In some embodiments of the present disclosure, the group field in type of group is added into the target table of the first document. The target cells associated with the group field may associate with a target group to quickly open or enter the target group through group field. Accordingly, the field type becomes more diversified and a quick jump of groups is implemented. Users may determine and record associated groups by adding a group field into a record of the table to quickly join or enter the group.

In some embodiments of the present disclosure, after associating a target cell corresponding to the group field with at least one target group, the method also comprises: displaying in the target cell identification information corresponding to the target group associated.

In some embodiments, identification information of associated target group is displayed in the target cell as shown in FIG. 6. The identification information corresponding to the target group may include: one or more of group profile, group name and group thumbnail etc., to facilitate users to understand with which group(s) the target cell is associated, wherein the group thumbnail may be displayed when the current user has the permission to view the group thumbnail. Without such permission, the group thumbnail is not displayed. A screenshot of the group chat interface may be displayed in the group thumbnail. It is very likely that some of the groups have similar names. In such case, the group thumbnail may make it more convenient for the users to determine the target group, to avoid wrong option of group by the users due to similar names.

In some embodiments, the opening or joining the target group in response to a third operation event based on the target cell includes: opening or joining a target group corresponding to identification information on which the third operation event is based in response to the third operation event executed on the basis of identification information in the target cell.

In some embodiments, the third operation event, for example, may be triggering the identification information. The target cell may associate with one or more target groups, and there may be one or more pieces of identification information as a result. However, the users may only want to access some of the target groups. Therefore, the identification information may be triggered by clicking, so as to open or join the target group corresponding to the triggered identification information, thereby fulfilling the function of selectively entering some of the target groups.

In some embodiments, the identification information corresponding to the target group in the target cell is updated in real time or periodically in case that an update occurs to information of the target group or the target group is dismissed. Alternatively, the identification information corresponding to the target group in the target cell is updated when the target group is associated with the target cell again or the target group is associated with other cells in case that an update occurs to information of the target group or the target group is dismissed.

In some embodiments, information of the target group, such as name and profile and the like may update. At this moment, it is also required to update the identification information in the target cell. In some embodiments, the update may be performed automatically in real time or periodically. In some further embodiments, the first document usually will not obtain the information of the group. However, when it is required to associate the cell with the group, the information of the group will be acquired. As such, the identification information of respective groups may be updated when the target group is associated with the cell, to reduce the number of communications and the data volume between the first document and the group.

In some embodiments of the present disclosure, a group contact card of the target group corresponding to the identification information is displayed in case that a fourth operation event is executed on the identification information, wherein the group contact card includes at least one of: a group name, a group profile, a group label and controls for opening or joining the target group.

In some embodiments, the fourth operation event, for example, may refer to the control mark suspending over the identification information. In such case, the group contact card of the target group is displayed as shown in FIG. 7, where group profile, group name and control (“open” in FIG. 7) are displayed in the group contact card. The controls are triggered to open or join the target group. In some embodiments, the third operation event for example may include performing the fourth operation event on the identification information and executing a trigger operation on the controls in the group contact card. That is, users may open or join the target group via the group contact card. In some embodiments, after the controls on the group contact card are triggered as shown in FIG. 8, a pop-up window is displayed for a second confirmation. The users may open or join the target group after the confirmation.

In some embodiments, the opening or joining the target group in response to a third operation event based on the target cell includes: opening or joining the target group in accordance with a belonging relationship between a current user performing the third operation event and the target group in response to a third operation based on the target cell.

In some embodiments, before opening or joining the target group, a determination is first made regarding a belonging relationship between the current user and the target group, to decide whether the current user has already joined the target group. In some embodiments, the first document and the target group are positioned in different applications that are associated with each other. The target group is in a communication client, and the users may open or join the target group by turning on the communication client.

In some embodiments, opening or joining the target group in accordance with a belonging relation between a current user performing the third operation event and the target group includes: if the current user has joined the target group, opening the target group; or if the current user has not joined the target group yet, joining the target group.

In some embodiments, if the current user is already in the target group, it indicates that the current user has the permission to access the target group. In such case, the target group is opened. If the current user is not in the target group, it means that the current user has no permissions to directly open the target group. Accordingly, the current user may join the target group. For example, an interface for applying to join the target group may display and the users may fill the application for joining through the interface.

In some embodiments of the present disclosure, the method comprises: in case that the current user has joined the target group which has already been dismissed, neither joining nor opening the target group after execution of third operation event, and displaying a first prompt message, the first prompt message indicating that the current user is not in the target group.

In some embodiments, since the target group has been dismissed, the users could neither join nor enter the target group. Therefore, after the execution of the third operation event, a first prompt message is displayed to indicate that the users are no longer in the target group.

In some embodiments of the present disclosure, the method comprises: in case that the current user has not joined the target group and the current user does not have permission to join the target group, neither joining nor opening the target group after execution of the third operation event, and displaying a second prompt message, the second prompt message indicating failure or error upon joining the target group.

In some embodiments, in order to join the target group, certain permissions are required. If the current users do not have such permissions, they cannot join the target group. At this time, after the execution of the third operation event, the users could not join or enter the target group. Instead, a second prompt message is displayed to indicate failure or error of joining the target group.

In some embodiments of the present disclosure, the method comprises: in case that the current user has not joined the target group yet and the target group has been dismissed or disabled or permission required for joining the target group has changed, neither joining nor opening the target group after execution of third operation event, and displaying a third prompt message, the third prompt message indicating that the current user could not join the target group.

In some embodiments, if the current user has not joined the target group yet and the target group has been dismissed or disabled or no longer exists, it is impossible to join the target group. Or if the permission required by the target group has changed and the current user consequently does not have the permission to join the target group, the target user could not join the target group. In such case, the third prompt message is displayed to notify that the current user could not join the target group.

In some embodiments of the present disclosure, associating a target cell corresponding to the group field with at least one target group in response to a second operation event includes: displaying optional groups in response to a first operation on the target cell; selecting at least one group from the optional groups in response to a second operation on the optional groups; establishing an association between the target cell and a group selected; wherein the group selected that establishes an association with the target cell is the target group.

In some embodiments, as shown in FIG. 5, when the target cell is not associated with a group, it is displayed in the default empty state. The control mark selects the target cell and the target cell changes into a focused state. At this time, the drop-down option is clicked to display the optional groups and search controls, and the target cell is now in an activated state. The optional group, after being selected, is associated with the target cell as the target group.

In some embodiments, the optional groups are groups for which a current user that executes the second operation event has default permissions. In some embodiments, the optional groups displayed may be groups visible to the current users. If a group is invisible to the current users due to its permission restriction, it will not be displayed in the optional groups.

In some embodiments, a search control for searching groups is displayed while the optional groups are displayed. In this way, the users may find the group via the search controls. In some embodiments, the search controls can only find groups for which the current users have default permissions, e.g., the groups visible to the current users.

In some embodiments, after at least one group is selected from the optional groups, identification information corresponding to the target group is displayed in the target cell; if a third operation is executed on the identification information, the identification information is deleted and deleted groups corresponding to the identification information are deselected. In some embodiments, according to the selected state shown in FIG. 5, after a group (e.g., group 2 in FIG. 5) is selected for the target cell, the identification information will be displayed and the current user may deselect the group by deleting the identification information.

In some embodiments of the present disclosure, the target cell is referenced to direct at a target group associated with the target cell. In some embodiments, the target cell of the group field may be referenced in the way of address, for example, in trigger conditions, determination conditions and execution operations. For instance, during transmission of communication messages, if it is expected that the target group associated with the target cell will transmit the communication message, the target cell may be configured as the receiving party. The target cell is referenced to direct towards the group indicated by the group field. In such case, dynamic referencing is implemented without specifying the specific group.

In some embodiments of the present disclosure, creating a group field in a target table of a first document in response to a first operation event includes: displaying a field creation interface in response to a fourth operation on a first control; determining that a field type of a field created is group and creating the group field in response to a second operation in the field creation interface.

In some embodiments, as shown in FIG. 2, an interface for adding a field (field creation interface) appears by clicking the addition sign (first control) at the top right corner of FIG. 2. According to FIG. 3, the title and field type options are displayed in the interface, where the title is the name of the column where the field is positioned. The field type may include an option list as shown in FIG. 3. The users may select a group type therein and click OK to create a group field that is not associated with a group.

In some embodiments of the present disclosure, the creating a group field in a target table of a first document in response to a first operation event includes: configuring attribute of a column of cells in a target table of the first document as group field in response to a first operation event, or adding in a target table of the first document a column of cells with group field attribute in response to a first operation event.

In some embodiments, field is the attribute of the cell. Creating a group field means creating a column of cells having group field attribute, or changing the cell tables whose attribute is not a group field into a column of cells with group field attribute.

In some embodiments of the present disclosure, the target group is a group in a communication client, which communication client is associated with an account of a current user. In some embodiments, the communication client may be a client bound with the first document. For example, the first document may be online document in the server of the communication client. The account of the current user is associated with the communication client, and the group is within the communication client. The communication client is determined based on the account of the current user, to further find the target group in the communication client. For example, the communication client may be instant messaging software or application and the group may be a chatting group within the software or application; alternatively, the communication client may be meeting software or application and the group may be a panel of members participating a meeting event in the meeting software or application; or the communication client may be a collaboration document software or application, and the group may be a panel of members of the collaboration space.

In some embodiments of the present disclosure, the target group is an email group in an email client, which email client is associated with an account of a current user. In some embodiments, an email group may be a communication group including at least one email contact. The email client may be bound with the first document, and the two may be located under two subprograms of the same collaborative office platform. The current account is associated with the email client, and the email client may be determined through the current account, so as to find the target group in the email client.

Some embodiments of the present disclosure also propose an information processing apparatus, comprising:
a creation unit for creating a group field in a target table of a first document in response to a first operation event;
a control unit for associating a target cell corresponding to the group field with at least one target group in response to a second operation event;
wherein the control unit also opens or joins the target group in response to a third operation event based on the target cell;
wherein the group field is a field with a field type of group.

In some embodiments, the control unit is also used for displaying in the target cell identification information corresponding to the target group associated after associating a target cell corresponding to the group field with at least one target group.

In some embodiments, the identification information corresponding to the target group includes: group profile, group name and/or group thumbnail.

In some embodiments, the opening or joining the target group in response to a third operation event based on the target cell includes:
opening or joining a target group corresponding to identification information on which the third operation event is based in response to the third operation event executed on the basis of identification information in the target cell.

In some embodiments, the control unit is also used for at least one of:
updating identification information corresponding to the target group in the target cell in real time or periodically in case that an update occurs to information of the target group or the target group is dismissed;
updating identification information corresponding to the target group in the target cell when the target group is associated with the target cell again or the target group is associated with other cells in case that an update occurs to information of the target group or the target group is dismissed;
displaying a group contact card of the target group corresponding to the identification information in case that a fourth operation event is executed on the identification information, wherein the group contact card includes at least one of: group name, group profile, group label and controls for opening or joining the target group.

In some embodiments, the opening or joining the target group in response to a third operation event based on the target cell includes:
opening or joining the target group in accordance with a belonging relation between a current user performing the third operation event and the target group in response to a third operation based on the target cell.

In some embodiments, opening or joining the target group in accordance with a belonging relation between a current user performing the third operation event and the target group includes:
if the current user has joined the target group, opening the target group; or
if the current user has not joined the target group yet, joining the target group.

In some embodiments, the control unit is also used for: in case that the current user has joined the target group which has already been dismissed, neither joining nor opening the target group after execution of third operation event, and displaying a first prompt message, the first prompt message indicating that the current user is not in the target group;

In some embodiments, the control unit is also used for: in case that the current user has not joined the target group yet and the current user does not have permission to join the target group, neither joining nor opening the target group after execution of the third operation event, and displaying a second prompt message, the second prompt message indicating failure or error upon joining the target group;

In some embodiments, the control unit is also used for: in case that the current user has not joined the target group yet and the target group has been dismissed or disabled or permission required for joining the target group has changed, neither joining nor opening the target group after execution of third operation event, and displaying a third prompt message, the third prompt message indicating that the current user could not join the target group.

In some embodiments, the associating a target cell corresponding to the group field with at least one target group in response to a second operation event includes:
displaying optional groups in response to a first operation on the target cell;
selecting at least one group from the optional groups in response to a second operation on the optional groups;
establishing an association between the target cell and a group selected;
wherein the group selected that establishes an association with the target cell is the target group.

In some embodiments, the optional groups are groups for which a current user that executes the second operation event has default permissions.

In some embodiments, a search control for searching groups is displayed while the optional groups are being displayed.

In some embodiments, after at least one group is selected from the optional groups, identification information corresponding to the target group is displayed in the target cell; if a third operation is executed on the identification information, the identification information is deleted and deleted groups corresponding to the identification information are deselected.

In some embodiments, the target cell is referenced to direct at a target group associated with the target cell.

In some embodiments, the creating a group field in a target table of a first document in response to a first operation event includes:
displaying a field creation interface in response to a fourth operation on a first control;
determining that a field type of a field created is group and creating the group field in response to a second operation in the field creation interface.

In some embodiments, the creating a group field in a target table of a first document in response to a first operation event includes:
configuring attribute of a column of cells in a target table of the first document as group field in response to a first operation event, or,
adding in a target table of the first document a column of cells with group field attribute in response to a first operation event.

In some embodiments, the target group is a group in a communication client, which communication client is associated with an account of a current user; or,
the target group is an email group in an email client, which email client is associated with an account of a current user.

Embodiments related to the apparatus basically correspond to the method embodiments, and relevant information may refer to the explanation of the method embodiments. The above described apparatus embodiments are only schematic, wherein modules depicted as discrete ones may or may not be separated. The objective of this embodiment solution may be implemented through selecting part or all of the modules in view of the actual needs. Those ordinary skilled in the art may appreciate and implement the solution without any exercises of inventive work.

Method and apparatus of the present disclosure have been explained above with reference to embodiments and application examples. Besides, the present disclosure also provides a terminal and a storage medium, which are to be depicted below.

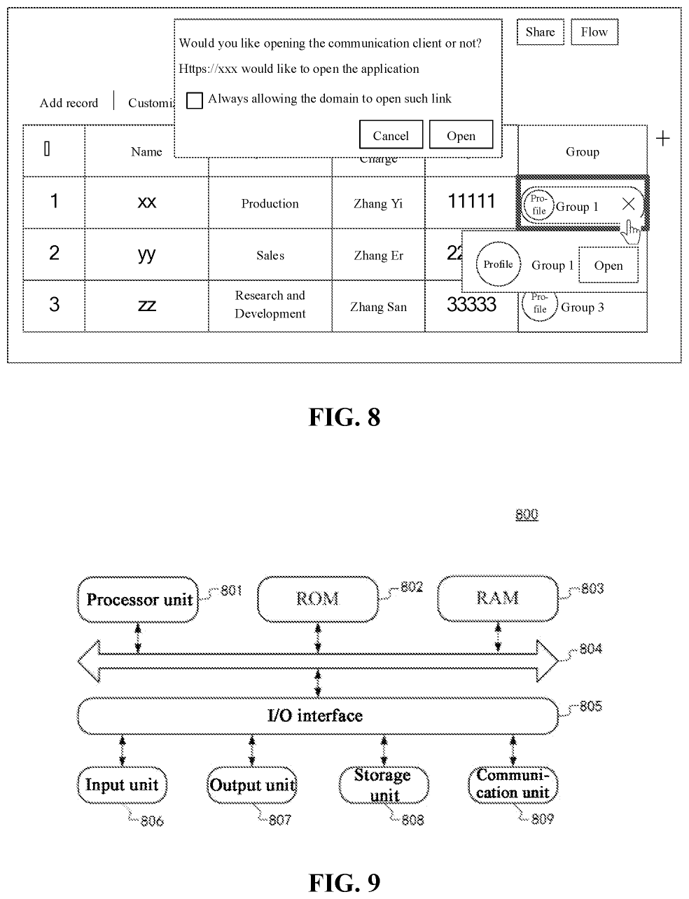

Next, FIG. 9 illustrates a structural diagram of an electronic device (e.g., terminal device or server) 800 suitable for implementing embodiments of the present disclosure. In the embodiments of the present disclosure, the terminal device may include, but not limited to, mobile terminals, such as mobile phones, notebooks, digital broadcast receivers, PDAs (Personal Digital Assistant), PADs (tablet computer), PMPs (Portable Multimedia Player) and vehicle terminals (such as car navigation terminal) and fixed terminals, e.g., digital TVs and desktop computers etc. The electronic device shown in FIG. 9 is just an example and will not put any restrictions on the functions and application ranges of the embodiments of the present disclosure.

According to FIG. 9, the electronic device 800 may include a processor (e.g., central processor, graphic processor and the like) 801, which can execute various suitable actions and processing based on the programs stored in the read-only memory (ROM) 802 or programs loaded in the random-access memory (RAM) 803 from a storage unit 808. The RAM 803 can also store all kinds of programs and data required by the operations of the electronic device 800. Processor 801, ROM 802 and RAM 803 are connected to each other via a bus 804. The input/output (I/O) interface 805 is also connected to the bus 804.

Usually, input unit 806 (including touch screen, touchpad, keyboard, mouse, camera, microphone, accelerometer, gyroscope and like) and output unit 807 (including liquid crystal display (LCD), speaker and vibrator etc.), storage unit 808 (including tape and hard disk etc.) and communication unit 809 may be connected to the I/O interface 805. The communication unit 809 may allow the electronic device 800 to exchange data with other devices through wired or wireless communications. Although FIG. 9 illustrates the electronic device 800 having various units, it is to be understood that it is not a prerequisite to implement or provide all illustrated units. Alternatively, more or less units may be implemented or provided.

In particular, in accordance with embodiments of the present disclosure, the process depicted above with reference to the flowchart may be implemented as computer software programs. For example, the embodiments of the present disclosure include a computer program product including computer programs carried on a non-transient computer readable medium, wherein the computer programs include program codes for executing the method demonstrated by the flowchart. In these embodiments, the computer programs may be loaded and installed from networks via the communication unit 809, or installed from the storage unit 808, or installed from the ROM 802. The computer programs, when executed by the processor 801, performs the above functions defined in the method according to the embodiments of the present disclosure.

It is to be explained the above disclosed computer readable medium may be computer readable signal medium or computer readable storage medium or any combinations thereof. The computer readable storage medium for example may include, but not limited to, electric, magnetic, optical, electromagnetic, infrared or semiconductor systems, apparatus or devices or any combinations thereof. Specific examples of the computer readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof. In the present disclosure, the computer readable storage medium may be any tangible medium that contains or stores programs. The programs may be utilized by instruction execution systems, apparatuses or devices in combination with the same.

In the present disclosure, the computer readable signal medium may include a data signal propagated in baseband or as part of a carrier wave, carrying computer readable program codes therein. Such propagated data signals may take many forms, including but not limited to, electromagnetic signals, optical signals, or any suitable combinations thereof. The computer readable signal medium may also be any computer readable medium in addition to the computer readable storage medium. The computer readable signal medium may send, propagate, or transmit programs for use by or in connection with instruction execution systems, apparatuses or devices. Program codes contained on the computer readable medium may be transmitted by any suitable media, including but not limited to: electric wires, fiber optic cables and RF (radio frequency) etc., or any suitable combinations thereof.

In some implementations, clients and servers may communicate with each other via any currently known or to be developed network protocols, such as HTTP (HyperText Transfer Protocol) and interconnect with digital data communications in any forms or media (such as communication networks). Examples of the communication networks include Local Area Network (LAN), Wide Area Network (WAN), internet work (e.g., Internet) and end-to-end network (such as ad hoc end-to-end network), and any currently known or to be developed networks.

The above computer readable medium may be included in the aforementioned electronic device or stand-alone without fitting into the electronic device.

The above computer readable medium bears one or more programs. When the above one or more programs are executed by the electronic device, the electronic device is enabled to execute the above method of the present disclosure.

Computer program instructions for executing operations of the present disclosure may be written in one or more programming languages or combinations thereof. The above programming languages include, but not limited to, object-oriented programming languages, e.g., Java, Smalltalk, C++ and so on, and traditional procedural programming languages, such as “C” language or similar programming languages. The program codes can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider).

The flow chart and block diagram in the drawings illustrate system architecture, functions and operations that may be implemented by system, method and computer program product according to various implementations of the present disclosure. In this regard, each block in the flow chart or block diagram can represent a module, a part of program segment or code, wherein the module and the part of program segment or code include one or more executable instruction for performing stipulated logic functions. In some alternative implementations, it should be noted that the functions indicated in the block can also take place in an sort different from the one indicated in the drawings. For example, two successive blocks can be in fact executed in parallel or sometimes in a reverse sort dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Units described in the embodiments of the present disclosure may be implemented by software or hardware. In some cases, the name of the unit should not be considered as the restriction over the unit per se.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

In the context of the present disclosure, machine readable medium may be tangible medium that may include or store programs for use by or in connection with instruction execution systems, apparatuses or devices. The machine readable medium may be machine readable signal medium or machine readable storage medium. The machine readable storage medium for example may include, but not limited to, electric, magnetic, optical, electromagnetic, infrared or semiconductor systems, apparatus or devices or any combinations thereof. Specific examples of the machine readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof.

In accordance with one or more embodiments of the present disclosure, there is provided an information processing method, comprising:
creating a group field in a target table of a first document in response to a first operation event;
associating a target cell corresponding to the group field with at least one target group in response to a second operation event;
opening or joining the target group in response to a third operation event based on the target cell;
wherein the group field is a field with a field type of group.

In accordance with one or more embodiments of the present disclosure, there is provided an information processing method. The method also comprises, after associating a target cell corresponding to the group field with at least one target group:
displaying in the target cell identification information corresponding to the target group associated.

In accordance with one or more embodiments of the present disclosure, there is provided an information processing method. The identification information corresponding to the target group includes: group profile, group name and/or group thumbnail.

In accordance with one or more embodiments of the present disclosure, there is provided an information processing method, wherein the opening or joining the target group in response to a third operation event based on the target cell includes:
opening or joining a target group corresponding to identification information on which the third operation event is based in response to the third operation event executed on the basis of identification information in the target cell.

In accordance with one or more embodiments of the present disclosure, there is provided an information processing method. The method satisfies at least one of:
updating identification information corresponding to the target group in the target cell in real time or periodically in case that an update occurs to information of the target group or the target group is dismissed;
updating identification information corresponding to the target group in the target cell when the target group is associated with the target cell again or the target group is associated with other cells in case that an update occurs to information of the target group or the target group is dismissed;
displaying a group contact card of the target group corresponding to the identification information in case that a fourth operation event is executed on the identification information, wherein the group contact card includes at least one of: group name, group profile, group label and controls for opening or joining the target group.

In accordance with one or more embodiments of the present disclosure, there is provided an information processing method, wherein the opening or joining the target group in response to a third operation event based on the target cell includes:
opening or joining the target group in accordance with a belonging relation between a current user performing the third operation event and the target group in response to a third operation based on the target cell.

In accordance with one or more embodiments of the present disclosure, there is provided an information processing method, wherein the opening or joining the target group in accordance with a belonging relation between a current user performing the third operation event and the target group includes:
if the current user has joined the target group, opening the target group; or
if the current user has not joined the target group yet, joining the target group.

In accordance with one or more embodiments of the present disclosure, there is provided an information processing method, comprising in case that the current user has joined the target group which has already been dismissed, neither joining nor opening the target group after execution of third operation event, and displaying a first prompt message, the first prompt message indicating that the current user is not in the target group;
or,
in case that the current user has not joined the target group yet and the current user does not have permission to join the target group, neither joining nor opening the target group after execution of the third operation event, and displaying a second prompt message, the second prompt message indicating failure or error upon joining the target group;
or,
in case that the current user has not joined the target group yet and the target group has been dismissed or disabled or permission required for joining the target group has changed, neither joining nor opening the target group after execution of third operation event, and displaying a third prompt message, the third prompt message indicating that the current user could not join the target group.

In accordance with one or more embodiments of the present disclosure, there is provided an information processing method, wherein the associating a target cell corresponding to the group field with at least one target group in response to a second operation event includes:
displaying optional groups in response to a first operation on the target cell;
selecting at least one group from the optional groups in response to a second operation on the optional groups;
establishing an association between the target cell and a group selected;
wherein the group selected that establishes an association with the target cell is the target group.

In accordance with one or more embodiments of the present disclosure, there is provided an information processing method. The method satisfies at least one of:
the optional groups are groups for which a current user that executes the second operation event has default permissions;
displaying a search control for searching groups while displaying the optional groups;
after selecting at least one group from the optional groups, displaying in the target cell identification information corresponding to the target group; if a third operation is executed on the identification information, deleting the identification information and deselecting deleted groups corresponding to the identification information.

In accordance with one or more embodiments of the present disclosure, there is provided an information processing method, wherein the target cell is referenced to direct at a target group associated with the target cell.

In accordance with one or more embodiments of the present disclosure, there is provided an information processing method, wherein the creating a group field in a target table of a first document in response to a first operation event includes:
displaying a field creation interface in response to a fourth operation on a first control;
determining that a field type of a field created is group and creating the group field in response to a second operation in the field creation interface.

In accordance with one or more embodiments of the present disclosure, there is provided an information processing method, wherein the creating a group field in a target table of a first document in response to a first operation event includes:
configuring attribute of a column of cells in a target table of the first document as group field in response to a first operation event, or,
adding in a target table of the first document a column of cells with group field attribute in response to a first operation event.

In accordance with one or more embodiments of the present disclosure, there is provided an information processing method, wherein the target group is a group in a communication client, which communication client is associated with an account of a current user; or,
the target group is an email group in an email client, which email client is associated with an account of a current user.

In accordance with one or more embodiments of the present disclosure, there is provided an information processing apparatus, comprising:
a creation unit for creating a group field in a target table of a first document in response to a first operation event;
a control unit for associating a target cell corresponding to the group field with at least one target group in response to a second operation event;
where in the control unit also opens or joins the target group in response to a third operation event based on the target cell;
wherein the group field is a field with a field type of group.

In accordance with one or more embodiments of the present disclosure, there is provided a terminal, comprising: at least one memory and at least one processor;
wherein the at least one memory is used for storing program codes and the at least one processor is used for calling program codes stored in the at least one memory to execute the above method.

In accordance with one or more embodiments of the present disclosure, there is provided a computer readable storage medium for storing program codes, wherein the program codes, when executed by a computer, enables the computer to perform the above method.

The above description only explains the preferred embodiments of the present disclosure and the technical principles applied. Those skilled in the art should understand that the scope of the present disclosure is not limited to the technical solution resulted from particular combinations of the above technical features, and meanwhile should also encompass other technical solutions formed from any combinations of the above technical features or equivalent features without deviating from the above disclosed inventive concept, such as the technical solutions formed by substituting the above features with the technical features disclosed here with similar functions.

Furthermore, although the respective operations are depicted in a particular sort, it should be appreciated that the operations are not required to be completed in the particular sort or in succession. In some cases, multitasking or multiprocessing is also beneficial. Likewise, although the above discussion comprises some particular implementation details, they should not be interpreted as limitations over the scope of the present disclosure. Some features described separately in the context of the embodiments of the description can also be integrated and implemented in a single embodiment. Conversely, all kinds of features described in the context of a single embodiment can also be separately implemented in multiple embodiments or any suitable sub-combinations.

Although the subject matter is already described by languages specific to structural features and/or method logic acts, it is to be appreciated that the subject matter defined in the attached claims is not limited to the above described particular features or acts. On the contrary, the above described particular features and acts are only example forms for implementing the claims.

I/We claim:

1. An information processing method comprising:
creating a group field in a target table of a first document in response to a first operation event;
associating a target cell corresponding to the group field with at least one target group in response to a second operation event;
opening or joining the target group in response to a third operation event based on the target cell;
wherein the group field is a field with a field type of group.

2. The method of claim 1, wherein the method further comprises, after associating the target cell corresponding to the group field with at least one target group,
displaying in the target cell identification information respectively corresponding to the associated target group.

3. The method of claim 1, wherein,
the identification information corresponding to the target group includes: group profile, a group name and/or a group thumbnail.

4. The method of claim 2, wherein opening or joining the target group in response to a third operation event based on the target cell comprises:
opening or joining the target group corresponding to identification information on which the third operation event is based in response to the third operation event executed based on identification information in the target cell.

5. The method of claim 2, wherein at least one of the following is satisfied:
updating the identification information corresponding to the target group in the target cell in real time or periodically in case that information of the target group is updated or the target group is dismissed;
updating the identification information corresponding to the target group in the target cell when the target group is associated with the target cell again or the target group is associated with other cells in case that the information of the target group is updated or the target group is dismissed;
displaying a group contact card of the target group corresponding to the identification information in case that a fourth operation event is executed on the identification information, wherein the group contact card includes at least one of: a group name, a group profile, a group label, and a control for opening or joining the target group.

6. The method of claim 2, wherein opening or joining the target group in response to a third operation event based on the target cell comprises:
opening or joining the target group based on a belonging relationship between a current user performing the third operation event and the target group in response to a third operation based on the target cell.

7. The method of claim 6, wherein opening or joining the target group based on a belonging relationship between a current user performing the third operation event and the target group comprises:
in case that the current user has joined the target group, opening the target group; or
in case that the current user has not joined the target group, joining the target group.

8. The method of claim 7, wherein
in case that the current user has joined the target group which has already been dismissed, neither joining nor opening the target group after performing third operation event, and displaying a first prompt message, the first prompt message indicating that the current user is not in the target group;
or,
in case that the current user has not joined the target group and the current user does not have permission to join the target group, neither joining nor opening the target group after performing the third operation event, and displaying a second prompt message, the second prompt message indicating failure or error upon joining the target group;
or,
if the current user has not joined the target group and the target group has been dismissed or disabled or permission required for joining the target group has changed, neither joining nor opening the target group after performing third operation event, and displaying a third prompt message, the third prompt message indicating that the current user can not join the target group.

9. The method of claim 1, wherein associating a target cell corresponding to the group field with at least one target group in response to a second operation event comprises:
displaying optional groups in response to a first operation on the target cell;
selecting at least one group from the optional groups in response to a second operation on the optional groups;
establishing an association between the target cell and the selected group;
wherein the selected group for which an association with the target cell is established is the target group.

10. The method of claim 9, wherein at least one of is satisfied:
the optional groups are groups for which a current user that executes the second operation event has default permissions;
displaying a search control for searching groups while displaying the optional groups;
after selecting at least one group from the optional groups, displaying in the target cell identification information corresponding to the target group; in case that a third operation is executed on the identification information, deleting the identification information and deselecting deleted groups corresponding to the identification information.

11. The method of claim 1, wherein,
the target cell is referenced by referencing a target cell and thereby directing to a target group associated with the target cell.

12. The method of claim 1, wherein creating a group field in a target table of a first document in response to a first operation event comprises:
displaying a field creation interface in response to a fourth operation on a first control;
determining that a field type of a field created is group and creating the group field in response to a second operation in the field creation interface.

13. The method of claim 1, wherein creating a group field in a target table of a first document in response to a first operation event comprises:
configuring attribute of a column of cells in a target table of the first document as the group field in response to a first operation event, or
adding, in a target table of the first document, a column of cells configured with the group field attribute in response to a first operation event.

14. The method of claim 1, wherein
the target group is a group in a communication client, the communication client is associated with an account of a current user; or
the target group is an email group in an email client, the email client is associated with an account of a current user.

15. A terminal, comprising:
at least one memory and at least one processor;
wherein the at least one memory is used for storing program codes, where the at least one processor is used for calling program codes stored in the at least one memory to:
create a group field in a target table of a first document in response to a first operation event;
associate a target cell corresponding to the group field with at least one target group in response to a second operation event;
open or join the target group in response to a third operation event based on the target cell;
wherein the group field is a field with a field type of group.

16. The terminal of claim 15, wherein the terminal is further caused to, after associating the target cell corresponding to the group field with at least one target group,
display in the target cell identification information respectively corresponding to the associated target group.

17. The terminal of claim 15, wherein,
the identification information corresponding to the target group includes: group profile, a group name and/or a group thumbnail.

18. The terminal of claim 16, wherein opening or joining the target group in response to a third operation event based on the target cell comprises:
opening or joining the target group corresponding to identification information on which the third operation event is based in response to the third operation event executed based on identification information in the target cell.

19. The terminal of claim 16, wherein at least one of the following is satisfied:
updating the identification information corresponding to the target group in the target cell in real time or periodically in case that information of the target group is updated or the target group is dismissed;
updating the identification information corresponding to the target group in the target cell when the target group is associated with the target cell again or the target group is associated with other cells in case that the information of the target group is updated or the target group is dismissed;
displaying a group contact card of the target group corresponding to the identification information in case that a fourth operation event is executed on the identification information, wherein the group contact card includes at least one of: a group name, a group profile, a group label, and a control for opening or joining the target group.

20. A computer readable storage medium for storing program codes, wherein the program codes, when executed by a computer, enables the computer to:
create a group field in a target table of a first document in response to a first operation event;
associate a target cell corresponding to the group field with at least one target group in response to a second operation event;
open or join the target group in response to a third operation event based on the target cell;
wherein the group field is a field with a field type of group.
